(19) United States
(12) Patent Application Publication
(10) Pub. No.: US 2007/0174889 A1
(43) Pub. Date: Jul. 26, 2007

(54) Optical network for bi-directional wireless communication

(75) Inventors: Yong-Gyoo Kim, Seoul (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/646,737

(22) Filed: Dec. 28, 2006

(30) Foreign Application Priority Data
Jan. 26, 2006 (KR) 2006-8306

(51) Int. Cl. H04N 7/173

(52) U.S. Cl. 725/129

(57) ABSTRACT

An optical network is provided. The optical network includes a station to convert a downstream radio frequency (RF) signal to a downstream optical signal and convert an upstream optical signal to an upstream RF signal; and a remote access unit (RAU) to convert the downstream optical signal to a downstream RF signal and to convert the upstream RF signal to the upstream optical signal, wherein the RAU determines a non-transmission band portion on which data is not carried from the downstream RF signal and inputs upstream data in the non-transmission band.

### CLAIM OF PRIORITY

This application claims priority under 35 U.S.C. § 119 to an application entitled “Optical Network for Bi-Directional Wireless Communication,” filed in the Korean Intellectual Property Office on Jan. 26, 2006 and assigned Serial No. 2006-8306, the contents of which are incorporated herein by reference.

### BACKGROUND OF THE INVENTION

1. Field of the Invention

The present invention relates to bi-directional wireless communication and in particular, to a bi-directional wireless communication network in which optical fiber and wireless communication are coupled.

2. Description of the Related Art

When using various wireless communication media, such as 2G, 3G, wireless local area network (WLAN), wireless Internet communication, and portable broadcasting, a large area/space is needed to construct base stations and/or relay stations. To optimize the area for a base station or a relay station, it is necessary to accommodate the various wireless communication media in an in-building type solution. Such a solution is commonly used for base stations and/or relay stations an existing optical communication networks. In an optical network for a radio over fiber (ROF) scheme wherein optical communication uses an optical fiber in a certain section and a wireless communication method in another section are combined have been suggested. The optical network of the ROF scheme can use heterogeneous data transmission methods, such as time division multiplexing (TDM) and sub-carrier multiplexing. Such heterogeneous data transmission methods are applied to various communication media and improve communication capacity and rate.

FIG. 1 is a schematic diagram of a conventional optical network 100 for wireless communication. Referring to FIG. 1, the conventional optical network 100 includes a central station (CS) 110, and a remote access unit (RAU) 120 linked to the CS 110 through an optical fiber.

The CS 110 includes an electro-optic converter 111 and an opto-electric converter 112. The electro-optic converter 111 converts a downstream radio frequency (RF) signal to a downstream optical signal. The opto-electric converter 112 converts an upstream optical signal input from the RAU 120 to an upstream RF signal. Each of the downstream and upstream optical signals is composed of a timeslot, a sub-carrier, and a broadcasting channel.

The RAU 120 includes an opto-electric converter 121 to convert the downstream optical signal to the downstream RF signal, a first amplifier 123 to amplify the downstream RF signal, a second amplifier 124 to amplify the upstream RF signal, an electro-optic converter 122 convert the amplified upstream RF signal to the upstream optical signal and output the converted upstream optical signal to the CS 110, an antenna 126 to receive the upstream RF signal and transmit the downstream RF signal, and a circulator 125 to output the downstream RF signal to the antenna 126 and output the upstream RF signal to the second amplifier 124.

FIG. 2 is a schematic diagram of another conventional optical network 200. Referring to FIG. 2, the conventional optical network 200 includes a CS 210 and an RAU 220, which are linked to each other through an optical fiber.

The CS 210 includes an electro-optic converter 211 to convert a downstream RF signal to a downstream optical signal and an opto-electric converter 212 to detect data by converting an upstream optical signal to an upstream RF signal. The downstream optical signal is composed of TDM timeslots, sub-carrier channels, a broadcasting channel, and a control signal. The upstream optical signal is composed of upstream timeslots and sub-carrier channels.

The RAU 220 includes an opto-electric converter 221 to convert the downstream optical signal to the downstream RF signal, an antenna 232 to transmit the downstream RF signal and receive the upstream RF signal, an electro-optic converter 222 to convert the upstream RF signal to the upstream optical signal, first and second amplifiers 225 and 231, a demultiplexer 223, a controller 224, first to third couplers 226, 228, and 227, and a switch 229.

The demultiplexer 223 extracts only a control signal from the downstream RF signal and outputs the extracted control signal to the controller 224. The controller 224 controls the switch 229 to alternatively input and output upstream and downstream timeslots. The first coupler 226 separates the downstream RF signal into a broadcasting channel, a sub-carrier channel, and a timeslot and outputs the separated timeslot to the switch 229. The separated sub-carrier channel is input to the second coupler 228 through the third coupler 227. The separated broadcasting channel is directly input to the second coupler 228.

The second coupler 228 couples the downstream timeslot, sub-carrier channel, and broadcasting channel into the downstream RF signal and outputs the downstream RF signal to the antenna 232. In addition, the second coupler 228 separates the upstream RF signal input from the antenna 232 into upstream sub-carrier channel and timeslot. The upstream timeslot separated by the second coupler 228 is input to the second amplifier 231 through the switch 229. The upstream sub-carrier channel is directly input to the second amplifier 231.

The controller 224 controls the switch 229 using a control signal. The switch 229 inputs/outputs the upstream and downstream timeslot(s), which are not overlapped.

However, when the timeslot and sub-carrier channel are used without being separated, there may be a problem of degradation due to mutual interference. In addition, when the timeslot and sub-carrier channel are separated and used, a separate control signal must be provided not to overlap the upstream and downstream timeslots.

### SUMMARY OF THE INVENTION

An object of the present invention is to substantially reduce or solve at least the above problems and/or disadvantages in the art. Accordingly, an object of the present invention is to provide a bi-directional wireless communication optical network for preventing degradation without a control signal.

According to the principles of the present invention, an optical network is provided includes a station to convert a downstream radio frequency (RF) signal to a downstream optical signal and convert an upstream optical signal to an upstream RF signal; and a remote access unit (RAU) to convert the downstream optical signal to a downstream RF signal and to convert the upstream RF signal to the upstream optical signal, wherein the RAU determines a non-transmission band portion on which data is not carried from the downstream RF signal and inputs upstream data in the non-transmission band.

### BRIEF DESCRIPTION OF THE DRAWINGS

The present invention will become more apparent from the following detailed description when taken in conjunction with the accompanying drawing in which:

FIG. 1 is a schematic diagram of a conventional optical network for wireless communication:

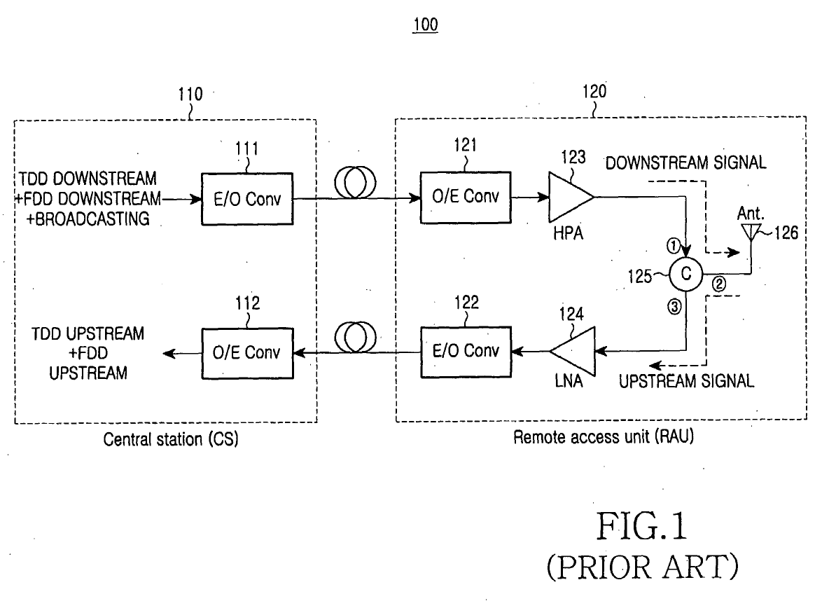

FIG. 2 is a schematic diagram of another conventional optical network;

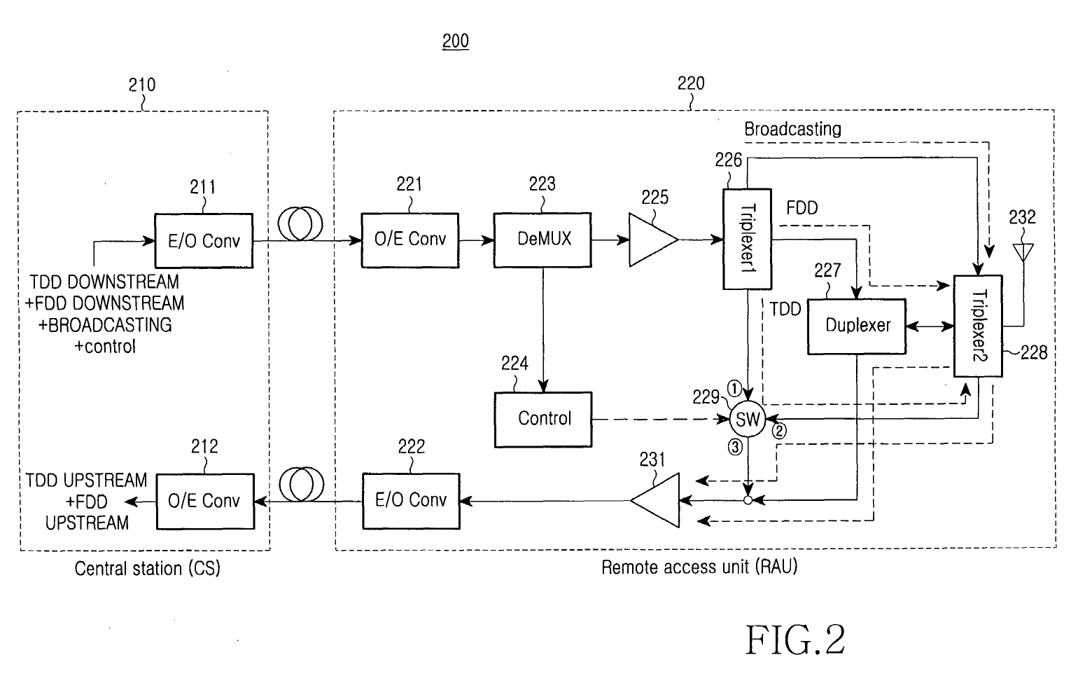

FIG. 3 is a schematic diagram of an optical network for bi-directional wireless communication according to a preferred embodiment of the present invention;

FIG. 4 is a block diagram of a controller of FIG. 3; and

FIG. 5 is a diagram showing a downstream timeslot input to the controller of FIG. 3 and a downstream timeslot output from a signal extractor.

### DETAILED DESCRIPTION OF THE INVENTION

Embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail since they would obscure the invention in unnecessary detail.

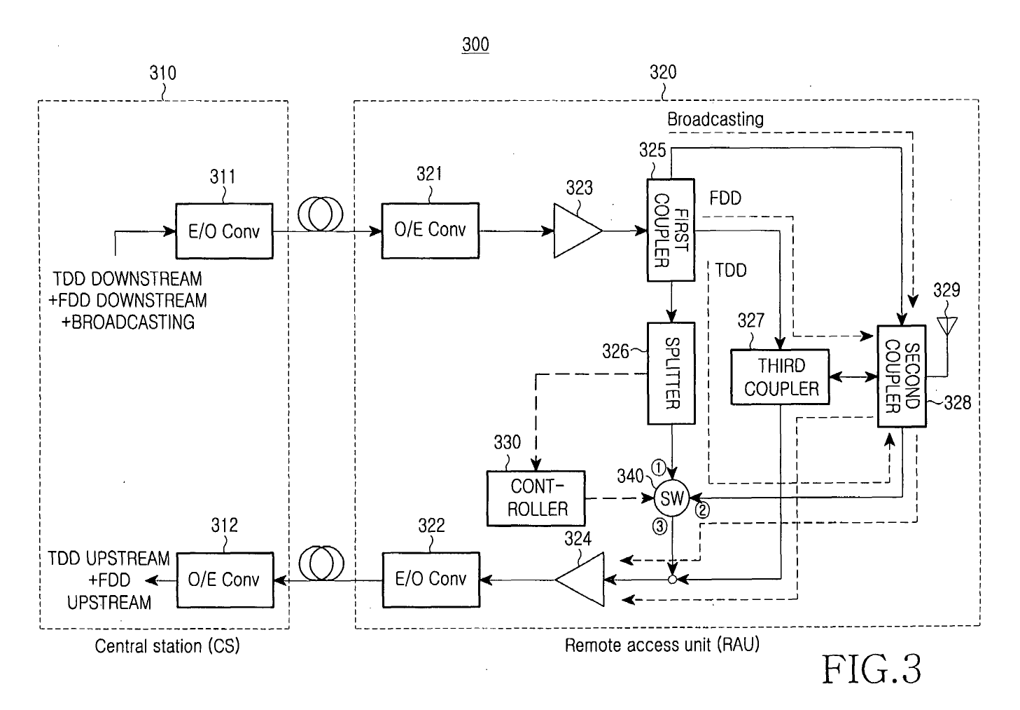

FIG. 3 is a schematic diagram of an optical network 300 for bi-directional wireless communication according to a preferred embodiment of the present invention. Referring to FIG. 3, the optical network 300 includes a station 310, hereinafter central station (CS) 310, to convert a downstream RF signal (composed of downstream channel and timeslot) to a downstream optical signal and convert an upstream optical signal to an upstream RF signal (composed of upstream channel and timeslot) and an RAU 320 to convert the downstream optical signal input from the CS 310 to a downstream RF signal and transmit the downstream RF signal and to convert the upstream RF signal received in a wireless manner to the upstream optical signal and transmit the upstream optical signal to the CS 310.

The CS 310 includes a downstream electro-optic converter 311 to convert the downstream RF signal to the downstream optical signal and an upstream converter 312 to convert the upstream optical signal to the upstream RF signal. The CS 310 can be linked to the RAU 320 through a wired line such as an optical fiber.

The RAU 320 includes a downstream opto-electric converter 321, an upstream electro-optic converter 322, first to third couplers 325, 328, and 327, first and second amplifiers 323 and 324, an antenna 329 for transmit the downstream RF signal and receive the upstream RF signal, a splitter 326, a switch 340, and a controller 330.

The downstream opto-electric converter 321 is linked to the downstream electro-optic converter 311 of the CS 310. The downstream converter 321 converts the downstream optical signal input from the CS 310 to the downstream RF signal, and outputs the downstream RF signal to the first coupler 325.

The first coupler 325 separates the downstream RF signal input from the downstream opto-electric converter 321 into a downstream timeslot, a downstream broadcasting channel, and a downstream sub-carrier channel. The downstream timeslot separated by the first coupler 325 is input to the splitter 326. The downstream broadcasting channel is input to the second coupler 328. The downstream sub-carrier channel is input to the second coupler 328 through the third coupler 327.

The upstream electro-optic converter 322 is linked to the upstream opto-electric converter 312 of the CS 310. The upstream electro-optic converter 322 converts the upstream RF signal to the upstream optical signal, and outputs the upstream optical signal to the CS 310.

The second coupler 328 separates the upstream RF signal input from the antenna 329 into an upstream timeslot, an upstream broadcasting channel, and an upstream sub-carrier channel. The second coupler 328 outputs the separated upstream timeslot to the switch 340, and directly outputs the separated upstream sub-carrier channel to the second amplifier 324. The second coupler 328 also couples the downstream broadcasting channel input from the first coupler 325, the downstream sub-carrier channel input from the third coupler 327, and the downstream timeslot input from the switch 340 into the downstream RF signal and outputs the downstream RF signal to the antenna 239.

The splitter 326 is located between the first coupler 325 and the switch 340. The splitter 326 splits a portion of the downstream timeslot separated by the first coupler 325. The splitter 326 outputs the split portion of the downstream timeslot to the controller 330 and the remaining portion of the downstream timeslot to the switch 340.

The controller 330 controls the switch 340 so that not to overlap the upstream and downstream timeslots input to the switch 340. The controller 330 determines a non-transmission band on which data is not carried from the downstream timeslot split by the splitter 326. The splitter 330 then controls the switch 340 to alternatively input and output the upstream and downstream timeslots by connecting a contact point to the splitter 326 or the second coupler 328.

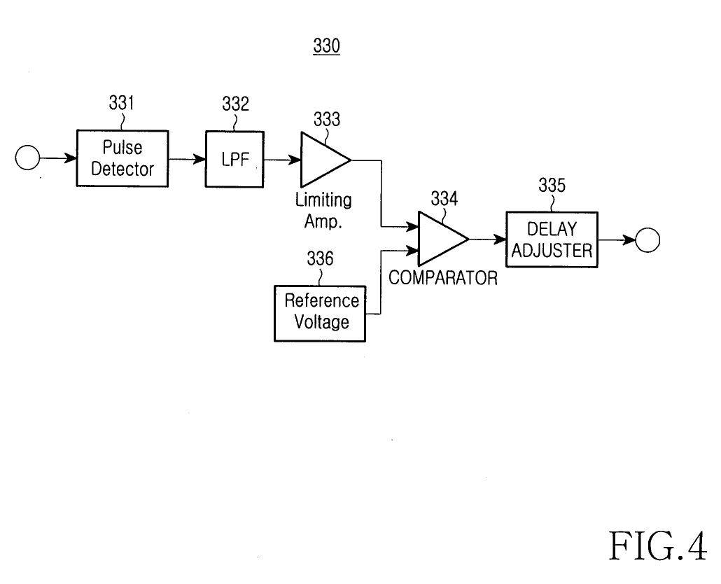

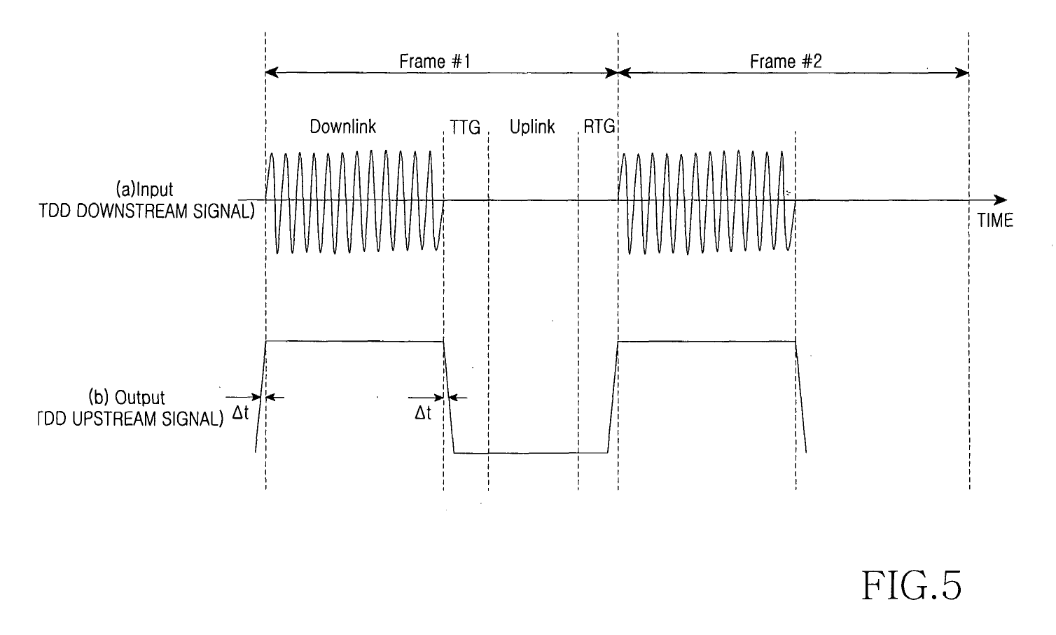

FIG. 4 is a block diagram of the controller 330 of FIG. 3. FIG. 5 is a diagram showing the downstream timeslot input to the controller 330 of FIG. 3 and a downstream timeslot output from a signal extractor (pulse detector). Referring to FIGS. 4 and 5, the controller 330 includes a pulse detector 331, a low pass filter (LPF) 332, a limiting amplifier 333, a comparator 334, a delay adjuster 335, and a reference voltage generator 336.

The pulse detector 331 detects an envelope pattern waveform as illustrated in FIG. 5A from the downstream timeslot input from the splitter 326. FIG. 5A shows the downstream timeslot, which is composed of a transmission band (Downlink) on which data is carried and a non-transmission band (TTG, Uplink, and RTG) on which data is not carried, input to the controller 330.

The TTG illustrated in FIG. 5A indicates an area to determine a trailing edge of the transmission band The RTG indicates an area to determine a leading edge of a subsequent timeslot. The Uplink commonly indicates an idle band for an upstream timeslot. In addition, the Δt illustrated in FIG. 5B indicates the time varying before and after data transmission of a timeslot.

The LPF 332 cancels noise, such as a ripple, from the timeslot waveform detected by the pulse detector 331. The limiting amplifier 333 limits the level of the timeslot input from the LPF 332.

The comparator 334 determines the non-transmission band by comparing a pre-set level of a reference voltage input from the reference voltage generator 336 to the level of the timeslot input from the limiting amplifier 333. The delay adjuster 335 controls the switch 340 so that the upstream timeslot can pass the switch 340 in the non-transmission band determined by the comparator 334.

Referring back to FIG. 3, the controller 330 controls the switch 340 to connect a first port (1) to the splitter 326 and a second port (2) to the second coupler 328 during the transmission band of the downstream timeslot. The controller 330 also controls the switch 340 to connect the second port (2) to the second coupler 328 and a third port (3) to the second amplifier 324 during the non-transmission band of the downstream timeslot.

The first amplifier 323 is located between the downstream opto-electric converter 321 and the first coupler 325. The first amplifier 323 amplifies the downstream RF signal and outputs the amplified downstream RF signal to the first coupler 325. The second amplifier 324 amplifies the upstream RF signal and outputs the amplified upstream RF signal to the upstream electro-optic converter 322.

The third coupler 327 outputs the downstream sub-carrier channel input from the first coupler 325 to the second coupler 328. In addition the third coupler 327 outputs the upstream sub-carrier channel input from the second coupler 328 to the second amplifier 324.

As described above, according to the principles of the present invention, by determining transmission and non-transmission bands from a downstream timeslot and controlling the downstream timeslot and an upstream timeslot, which are not overlapped, a CS does not have to input a separate control signal. Moreover, a separate control signal does not have to be input to an electro-optic converter. Thus, the modulation index of channels and timeslot can be increased.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical network for bi-directional wireless communication comprising:
a station to convert a downstream radio frequency (RF) signal to a downstream optical signal and convert an upstream optical signal to an upstream RF signal; and
a remote access unit (RAU) to convert the downstream optical signal to a downstream RF signal and to convert the upstream RF signal to the upstream optical signal, wherein the RAU determines a non-transmission band portion on which data is not carried from the downstream RF signal and inputs upstream data in the non-transmission band.

2. The optical network of claim 1, wherein the RF signal includes a downstream channel and timeslot and the upstream RF signal includes an upstream channel and timeslot.

3. The optical network of claim 2, wherein the RAU determines the non-transmission band portion on which data is not carried from the downstream timeslot and inputs the upstream timeslot in the non-transmission band.

4. The optical network of claim 1, wherein the station comprises:
a downstream electro-optic converter to convert the downstream RF signal to the downstream optical signal; and
an upstream opto-electric converter to convert the upstream optical signal to the upstream RF signal.

5. The optical network of claim 1, wherein the RAU comprises:
a downstream opto-electric converter to convert the downstream optical signal to the downstream RF signal;
an upstream electro-optic converter to convert the upstream RF signal to the upstream optical signal;
an antenna to transmit the downstream RF signal and receive the upstream RF signal;
a first coupler to separate the downstream RF signal converted by the downstream opto-electric converter into a downstream timeslot, a downstream broadcasting channel, and a downstream sub-carrier channel;
a second coupler to separate the upstream RF signal into an upstream timeslot, an upstream broadcasting channel, and an upstream sub-carrier channel;
a splitter to split a portion of the downstream timeslot separated by the first coupler;
a switch to alternatively input and output the upstream and downstream timeslots; and
a controller to control the switch to input and output the upstream and downstream timeslots by determining a non-transmission band on which data is not carried from the downstream timeslot split by the splitter.

6. The optical network of claim 3, wherein the RAU further comprises:
a first amplifier located between the downstream opto-electric converter and the first coupler, wherein the first amplifier amplifies the downstream RF signal, and outputs the amplified downstream RF signal to the first coupler;
a second amplifier to amplify the upstream RF signal and output the amplified upstream RF signal to the upstream electro-optic converter; and
a third coupler to output the downstream sub-carrier channel input from the first coupler to the second coupler and output the upstream sub-carrier channel input from the second coupler to the second amplifier.

7. The optical network of claim 3, wherein the controller comprises:
a pulse detector to detect an envelope pattern waveform from the downstream timeslot;
a band pass filter (BPF) to cancel noise from the timeslot waveform detected by the pulse detector;
a limiting amplifier to limit the level of the timeslot input from the BPF;
a reference voltage generator to generate a reference voltage having a pre-set level;
a comparator to detect a non-transmission band by comparing the reference voltage level of the reference voltage generator to the level of the timeslot input from the limiting amplifier; and
a delay adjuster to control the switch so that the upstream timeslot can pass the switch in the non-transmission band determined by the comparator.
